(19) United States
(12) Patent Application Publication
(10) Pub. No.: US 2005/0132043 A1
(43) Pub. Date: Jun. 16, 2005

(54) System and method for command line interface command processing

(75) Inventors: Gong-Qian Wang, Shenzhen (CN); Tang He, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/991,000

(22) Filed: Nov. 17, 2004

(30) Foreign Application Priority Data
Dec. 12, 2003 (TW) 92135151

(51) Int. Cl. G06F 15/173

(52) U.S. Cl. 709/224

(57) ABSTRACT

A system (100) for CLI command processing is usable for configuring and administering electronic devices. The system includes: an I/O controlling module (110) for receiving input commands from a console or a terminal; a command parsing module (120) for parsing each character in the input commands, and separating the input commands into a job parent command and plural job child commands; a job controlling module (130) for executing the job parent command and job child commands; and a mode controlling module (140) for selecting an appropriate mode for inputting of commands by a user. The job controlling module comprises a job list (131), which stores the command information structures of the job parent command and job child commands. A related method is also provided.

### BACKGROUND OF THE INVENTION

1. Field of the Invention

The present invention relates to a system and method for Command Line Interface (CLI) command processing; and more particularly to a system and method for CLI command processing, usable for configuring and administering electronic devices such as routers and switches.

2. Prior Art of the Invention

A user interface is a management tool supported by software. A typical user interface enables users to configure and monitor electronic devices. The user interface usually transmits commands input by the users to the electronic devices, whereupon the input commands are parsed by internal programs of the electronic devices. Subsequently, tasks indicated by the commands are executed. Nowadays there are two common kinds of user interfaces: one is the CLI, the other is a Graphical User Interface (GUI).

A GUI is a user interface based on graphics such as toolbars, menus, icons, buttons, and dialogue boxes. Users can input commands by clicking on the graphics using a computer mouse. A CLI is a user interface based on textual input and output. The users input keywords and parameters representing commands by use of a keyboard or similar input device. Then the commands are parsed and executed by corresponding internal programs of the electronic devices. Finally, results of the commands are output to the users on the CLI in the form of text.

Because GUI command processing uses a lot of controlling graphics, the memory needed to support GUI command processing is large compared to that of CLI command processing. When the above-mentioned controlling graphics of the GUI interface are invoked, additional memory is required. Therefore the speed of GUI command processing is slower than that of CLI command processing.

During CLI command processing, a mechanism for parsing commands is involved. The mechanism for parsing commands is usually a system that matches the input commands with attribute values, wherein the attribute values correspond to certain executers. The commands that are supported by the user interface include commands for configuring the electronic devices, and commands for retrieving information on states of the electronic devices. Therefore, for CLI command processing to be efficient, the mechanism for parsing commands must be efficient.

A method for parsing commands is disclosed in China Pat. No. 00125204.6, which issued on Feb. 20, 2002 and is entitled “Method of storage and parse of commands used for maintaining of routers.” The method employs a tree format list to store several segments of input commands. The mechanism used in the patent is quite different from random storage of commonly used parsing mechanisms. The tree format list used in the patent can quickly match the input commands with corresponding attribute values.

What is still needed is a system and method which efficiently process commands that are input through a CLI interface.

### SUMMARY OF THE INVENTION

Accordingly, an object of the present invention is to provide an efficient system for CLI command processing, which enables users to configure, monitor and maintain electronic devices.

Another object of the present invention is to provide an efficient method of CLI command processing, which enables users to configure, monitor and maintain electronic devices.

In order to accomplish the first of the above-mentioned objects, a system for CLI command processing comprises an I/O (input/output) controlling module, a command parsing module, a job controlling module and a mode controlling module. The I/O controlling module is provided for receiving input commands from a console or a terminal. The command parsing module parses each character in the input commands, and assigns corresponding meanings to special characters. The job controlling module builds up a tree format list for storage of the input commands, and then executes the input commands. The mode controlling module provides different kinds of modes for inputting of commands, the modes being selectable according to user need.

In order to accomplish the second of the above-mentioned objects, a method of CLI command processing comprises the following steps: (a) receiving input commands from a console or terminal, and transmitting the input commands to the command parsing module; (b) checking whether there are special characters in the input commands; (c) separating the input commands into a job parent command and plural job child commands, and building up command information structures; (d) checking whether all the command information structures are valid; (e) transmitting the valid command information structures to a job controlling module, if all the command information structures are valid; and (f) executing tasks indicated by the valid command information structures.

Other objects, advantages and novel features of the present invention will be drawn from the following detailed description with the attached drawings, in which:

### BRIEF DESCRIPTION OF THE DRAWINGS

FIG. 1 is a schematic diagram of a system for CLI command processing in accordance with a preferred embodiment of the present invention;

FIG. 2 is a flow chart of a preferred method of CLI command processing in accordance with the present invention.

FIG. 3 is a flow chart of details of one step of FIG. 2, namely executing tasks indicated by valid command information structures.

FIG. 4 is a flow chart of details of one step of FIG. 3, namely making a main process check and control each of child processes.

### DETAILED DESCRIPTION OF PREFERRED EMBODIMENTS OF THE INVENTION

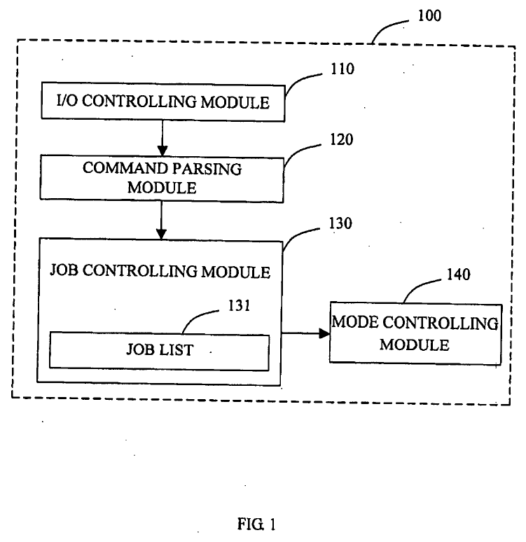

FIG. 1 is a schematic diagram of a system 100 for CLI command processing in accordance with the preferred embodiment of the present invention, which is for users to configure, monitor, and maintain electronic devices. The system 100 comprises an I/O controlling module 110, a command parsing module 120, a job controlling module 130, and a mode controlling module 140. The job controlling module 130 comprises a job list 131. The I/O controlling module 110 is provided for receiving input commands from a console, a terminal or a remote client. The input commands may be command strings or special characters such as &, >, < etc.

The command parsing module 120 is provided for parsing each of characters among the input commands transmitted from the I/O controlling module 110. The command parsing module 120 performs the following tasks: (1) assigning certain meanings to the characters; (2) separating the command into a job parent command and a plurality of job child commands; and (3) building up corresponding command information structures for the job parent command and the job child commands, and subsequently checking their validity. The command information structures comprise plural parameters, which represent corresponding tasks.

The job controlling module 130 has the following functions: (1) receiving command information structures of the job parent command and the job child commands, and storing them in the job list 131 in a tree format; (2) executing tasks indicated by the command information structures; (3) building up a main process for the job parent command and child processes for each of the job child commands during operation; and (4) making the main process check and control each of the child processes. That is, the main process checks a status of each job child process. If the child process has exited, the main process transmits data from a previous child process to a next child process through a pipe or some redirect files. The pipe is a method of connecting the standard output of one process to the standard input of another process. The redirect files are provided for storing input data and output data of processes. Therefore the child processes are executed one by one under the control of the main process, such that the tasks indicated by the input commands are executed.

The mode controlling module 140 is provided for selecting a corresponding working mode according to requirements of the users. There are five kinds of working modes supported by the mode controlling module 140: an execute mode, a privilege mode, a global configure mode, a DHCP (Dynamic Host Configuration Protocol) pool configure mode, and an interface configure mode. Different passwords are provided by the mode controlling module 140 for access to the five kinds of working modes. Each mode provides different commands for the users to configure and maintain the electronic devices.

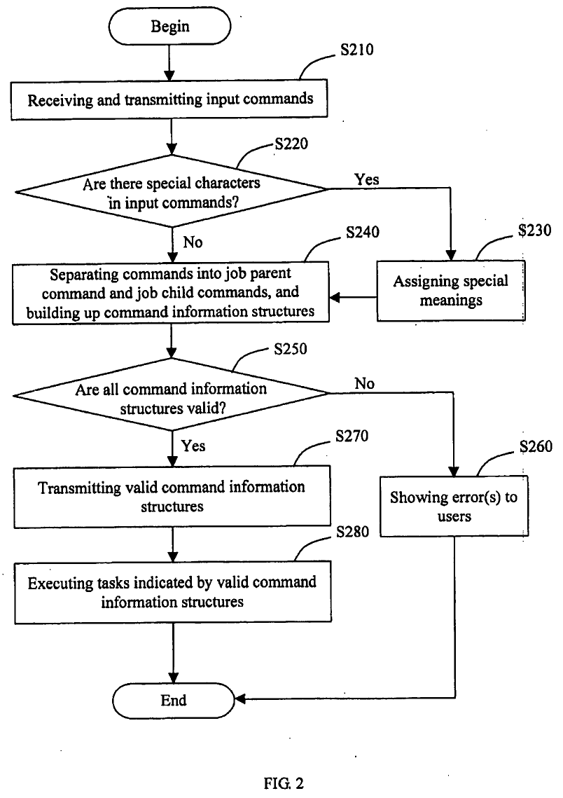

FIG. 2 is a flow chart of the preferred method of CLI command processing in accordance with the present invention. At step S210, the I/O controlling module 110 receives input commands (strings or characters) from the console, the terminal or the remote client, and then transmits them to the command parsing module 120. At step S220, the command parsing module 120 checks whether there are special characters in the input commands; if so, the procedure goes to step S230. Otherwise, the procedure goes directly to step S240. At step S230, the command parsing module 120 assigns special meanings to the special characters, whereupon the procedure goes to step S240. At step S240, the command parsing module 120 separates the command into a job parent command and several job child commands, and subsequently builds up command information structures for the job parent command and all of the job child commands. At step S250, the command parsing module 120 checks whether all of the command information structures are valid; if so, the procedure goes to step S270. Otherwise, the procedure goes to step S260. At step S260, the command parsing module 120 shows an error for each invalid command information structure to corresponding users, whereupon the procedure is finished. At step S270, the command parsing module 120 transmits the valid command information structures to the job controlling module 130. At step S280, the job controlling module 130 executes tasks indicated by the valid command information structures, whereupon the procedure is finished.

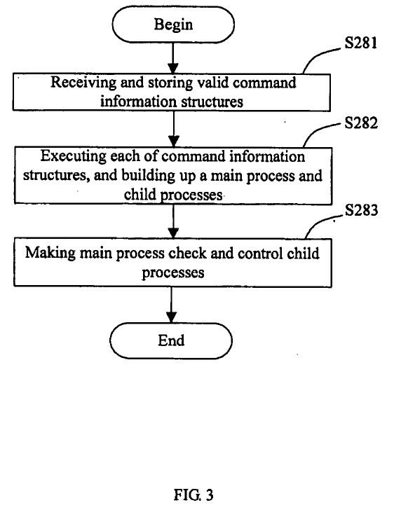

FIG. 3 is a flow chart of details of step S280 of FIG. 2, namely executing tasks indicated by the valid command information structures. At step S281, the job controlling module 130 receives the command information structures of the job parent command and job child commands, and stores these command information structures in the job list 131 in a tree format. At step S282, the job controlling module 130 executes each of the command information structures, and at the same time builds up a main process for the job parent command and child processes for all of the job child commands. At step S283, the job controlling module 130 makes the main process check and control each of the child processes.

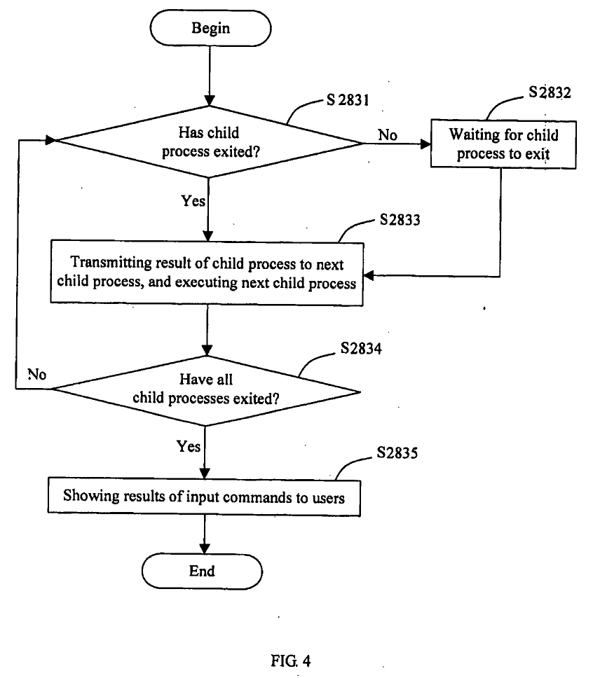

FIG. 4 is a flow chart of details of step S283 of FIG. 3, namely making the main process check and control each of the child processes. At step S2831, the main process checks whether a child process has exited. If so, the procedure goes directly to step S2833. Otherwise, the procedure goes to step S2832. At step S2832, the main process waits for the child process to exit. Once the child process has exited, the procedure goes to step S2833. At step S2833, the main process transmits the result of the child process to a next child process, and executes the next child process. At step S2834, the main process checks whether all of the child processes have exited. If so, the procedure goes to step S2835. Otherwise, the procedure returns to step S2831 in respect of another child process. At step S2835, the job controlling module 130 shows results of input commands to corresponding users.

Although only a preferred embodiment and method of the present invention have been described in detail above, those skilled in the art will readily appreciate that many modifications to the preferred embodiment and method are possible without materially departing from the novel teachings and advantages of the present invention. Accordingly, all such modifications are deemed to be covered by the following claims and allowable equivalents of the claims.

1. A system for CLI (Command Line Interface) command processing, the system being usable for configuring and administering electronic devices, the system comprising:
an I/O (input/output) controlling module, for receiving input commands from a console or terminal;
a command parsing module, for parsing each character in the input commands, and separating the input commands into a job parent command and plural job child commands;
a job controlling module, for carrying out the job parent command and job child commands; and
a mode controlling module, for selecting an appropriate mode for inputting of commands by a user.

2. The system for CLI command processing as recited in claim 2, wherein the command parsing module builds up command information structures for the job parent command and the job child commands.

3. The system for CLI command processing as recited in claim 1, wherein the job controlling module comprises a tree format job list for storing the command information structures of the job parent command and the job child commands.

4. The system for CLI command processing as recited in claim 1, wherein the mode controlling module supports an execute mode, a privilege mode, a global configure mode, a DHCP (Dynamic Host Configuration Protocol) pool configure mode, and an interface configure mode.

5. The system for CLI command processing as recited in claim 4, wherein access to each of said modes is controlled by a respective password.

6. A method of CLI command processing, the method being usable for configuring and administering electronic devices, the method comprising the following steps:
receiving input commands from a console or terminal, and transmitting the input commands to a command parsing module;
checking whether there are special characters in the input commands;
separating the input commands into a job parent command and plural job child commands, and building up command information structures;
checking whether all the command information structures are valid;
transmitting the valid command information structures to a job controlling module, if all the command information structures are valid; and
executing tasks indicated by the valid command information structures.

7. The method of CLI command processing as recited in claim 6, further comprising the following step: assigning meanings to the special characters and then performing step (c), if the input commands include special characters.

8. The method of CLI command processing as recited in claim 6, further comprising the following step:
showing an error to one or more users, if there is any invalid command information structure.

9. The method of CLI command processing as recited in claim 6, wherein step (f) comprises the following steps:
(f1) receiving and storing the valid command information structures;
(f2) executing each of the valid command information structures, and building up a main process and plural child processes; and
(f3) making the main process check and control the child processes.

10. The method of CLI command processing as recited in claim 9, wherein step (f3) comprises the following steps:
(f31) checking whether a child process has exited;
(f32) transmitting a result of the child process to a next child process, and executing the next child process, if the child process has exited;
(f33) checking whether all of child processes have exited; and
(f34) showing one or more results to said users, if all of the child processes have exited.

11. The method of CLI command processing as recited in claim 10, further comprising the following step: waiting for the child process to exit, if the child process has not exited.

12. The method of CLI command processing as recited in claim 10, further comprising the following step: returning to step (f31) in respect of another child process, if there is any child process that has not exited.

13. A method of command line interface (CLI) command processing to configure and administer electronic devices, comprising the following steps:
acquiring input commands from a user via said CLI;
parsing said input commands into a plurality of electronic-device recognizable job commands and command information structures;
creating process check information based on said command information structures; and
executing said job commands and command information structures under a process check based on said process check information.

14. The method as recited in claim 13, further comprising the step of selecting working modes of said CLI command processing on an access-controlled basis.
